(19) United States
(12) Patent Application Publication
(10) Pub. No.: US 2012/0189256 A1
(43) Pub. Date: Jul. 26, 2012

(54) Fiber Optic Cable Systems and Methods for Forming the Same

(76) Inventors: Barry Wayne Allen, Siler City, NC (US); Julian Mullaney, Raleigh, NC (US)

(21) Appl. No.: 13/010,158

(22) Filed: Jan. 20, 2011

(51) Int. Cl. G02B 6/44; B23P 11/00

(52) U.S. Cl. 385/112; 29/461

(57) ABSTRACT

A fiber optic cable system includes a fiber optic main cable having a longitudinal central axis and an outer cable sheath. An outer optical fiber tube is located within the fiber optic main cable proximate the outer cable sheath and including a plurality of optical fibers extending therein and an inner optical fiber tube is located within the fiber optic main cable closer to the longitudinal central axis of the fiber optic main cable than the outer optical fiber tube and including an optical fiber extending therein. A first splice location in the fiber optic main cable is at a first longitudinal position along the fiber optic main cable. One of the plurality of optical fibers in the outer optical fiber tube is cut at the first splice location. A first section of the cut optical fiber extends from the cut towards a first longitudinal end of the fiber optic main cable and a second section of the cut optical fiber extends from the cut to a second end of the fiber optic main cable that is longitudinally displaced from the first end. A splice at the second end of the fiber optic main cable couples the second section of the cut optical fiber to the optical fiber in the inner optical fiber tube. As such, easier access may be provided to inner tube fibers using sections of the outer tube fibers.

### BACKGROUND OF THE INVENTION

The present invention relates to communication cable termination systems and, more particularly, to optical fiber termination systems and methods for terminating the same.

An extensive infrastructure supporting telecommunication has been developed, traditionally based upon copper wire connections between individual subscribers and telecommunications company network distribution points. More recently, much of the telecommunications network infrastructure is being extended or replaced with an optical fiber based communications network infrastructure. The carrying capacity and communication rate capabilities of such equipment may exceed that provided by conventional copper wired systems.

As such, fiber optic cables are widely used for telecommunications applications where high information capacity, noise immunity and other advantages of optical fibers may be exploited. Fiber cable architectures are emerging for connecting homes and/or business establishments, via optical fibers, to a central location, for example. A trunk or main cable may be routed, for example, through a housing subdivision and small fiber count “drop cables” may be spliced to the main cable at predetermined spaced apart locations.

A typical main cable may be installed underground and have multiple drop cables connected thereto, each of a hundred feet or more. Each of the drop cables, in turn, may be routed to an optical network unit (ONU) serving one or more homes. Information may then be transmitted optically to the ONU, and into the home, via optical fiber or conventional copper cable technology. Thus, the drop cables may serve groups of users, although other architectures may also employ a main cable and one or more drop cables connected thereto.

Unfortunately, the fibers within the main cable must typically be accessed at the various drop points and spliced to respective drop cables after the main cable has already been installed. Accessing the main cable for splicing generally requires careful preparation of the main cable including removing a portion of the cable sheath, and identifying and separating out predetermined fibers from within the cable without disturbing adjacent fibers. The separated fibers may then be spliced and secured within a conventional protective splice closure. Moreover, these cable access and splicing steps must typically be accomplished in the field by a technician who is likely to experience difficulties imposed by weather or the particular location of each of the drop points. Accordingly, field splicing of drop cables to a main cable is typically time consuming, expensive, and may produce low quality optical splices.

In an effort to overcome the disadvantages of field splicing drop cables at each of a series of drop points, so-called preterminated fiber optic cables have been proposed. A preterminated fiber optic cable includes a relatively high fiber count main cable to which respective low fiber count drop cables are spliced at predetermined drop points. The locations of the drop points may be determined based upon field survey measurements.

The splicing of the drop cables to the main cable of a preterminated cable is generally performed at the factory during manufacturing of the cable. The preterminated cable, including the main cable, drop cables, and associated splice closures, are desirably wound onto a cable reel and delivered to the installation site. Accordingly, conditions for making high quality splices may be maximized in the factory, thereby potentially increasing splice quality and also reducing the expense and difficulty associated with field splicing.

For the optical fiber infrastructure, it is generally desirable to provide sealed environmental protection and flexible incremental connection of subscriber drop cables to provide for rapid and reduced cost deployment of services to different customers. A variety of different products are available for use at access points in optical fiber-based communications networks. For example, the OptiSheath™ Advantage Terminal, available from Corning Incorporated of Corning, N.Y., is available with customer options to accommodate add-as-you-grow applications. The OptiSheath™ is available in six, eight or twelve port customer options, which may be utilized for aerial or buried terminal use in an optical access architecture allowing for subscriber connection. Cables of varying lengths may be preterminated inside the factory for use in the OptiSheath™ Advantage Terminal and the multiport options may allow for configuration in the field of each terminal location based on customer take length and stub length. The actual connection point in the OptiSheath™ Advantage Terminal utilizes a specific tap and drop cable specification to provide for the actual subscriber drop cable installation at the OptiSheath™ Advantage Terminal. In particular, the OptiTap™ Connector is included in the OptiSheath™ Advantage Terminal and the OptiFit™ Drop Cable may be removably coupled through the OptiTap™ to link subscribers to the optical fiber communications network. Utilization of such a standard connector type infrastructure may provide for rapid installation of fiber optic cables.

### SUMMARY OF THE INVENTION

Some embodiments of the present invention include fiber optic cable systems that include a fiber optic main cable having a longitudinal central axis and an outer cable sheath. An outer optical fiber tube is located within the fiber optic main cable proximate the outer cable sheath and including a plurality of optical fibers extending therein and an inner optical fiber tube is located within the fiber optic main cable closer to the longitudinal central axis of the fiber optic main cable than the outer optical fiber tube and including an optical fiber extending therein. A first splice location in the fiber optic main cable is at a first longitudinal position along the fiber optic main cable. One of the plurality of optical fibers in the outer optical fiber tube is cut at the first splice location. A first section of the cut optical fiber extends from the cut towards a first longitudinal end of the fiber optic main cable and a second section of the cut optical fiber extends from the cut to a second end of the fiber optic main cable that is longitudinally displaced from the first end. A splice at the second end of the fiber optic main cable couples the second section of the cut optical fiber to the optical fiber in the inner optical fiber tube. As such, easier access may be provided to inner tube fibers using sections of the outer tube fibers.

In further embodiments, the system further includes a second splice location in the fiber optic main cable at a second longitudinal position along the fiber optic main cable between the first longitudinal position and the second end of the fiber optic main cable. The second section of the cut optical fiber is cut at the second splice location. The first splice location may be a first opening in the fiber optic main cable and the cut optical fiber may be exposed by the first opening. The second splice location may be a second opening in the fiber optic main cable and the cut second section of the cut optical fiber may be exposed by the second opening.

In other embodiments, the system further includes a first drop cable having an optical fiber therein. The first drop cable optical fiber is spliced to the first section of the cut optical fiber at the first opening. A second drop cable has an optical fiber therein. The second drop cable optical fiber is spliced to the cut second section of the cut optical fiber at the second opening to couple the second drop cable optical fiber to the optical fiber in the inner optical fiber tube. Additional optical fibers may extend in the inner optical fiber tube and the cut optical fiber may be a plurality of cut optical fibers in the outer optical fiber tube. The splice at the second end of the fiber optic main cable may be a plurality of splices that couple ones of the additional optical fibers in the inner optical fiber tube to respective ones of the cut optical fibers in the outer optical fiber tube. Additional drop cables having optical fibers therein may be provided. The additional drop cable optical fibers may be spliced to respective ones of the cut optical fibers in the outer optical fiber tube to couple the additional drop cable optical fibers to the additional optical fibers in the inner optical fiber tube.

In further embodiments, the outer optical fiber tube is a plurality of outer optical fiber tubes and the inner optical fiber tube is a plurality of inner optical fiber tubes. A plurality of additional openings in the fiber optic main cable may be provided. The additional drop cable optical fibers may be spliced to respective ones of the cut optical fibers in the outer optical fiber tube at respective ones of the additional openings to provide a factory preterminated optical fiber cable having a plurality of drop cables spliced to the fiber optic main cable.

In yet other embodiments, a splice closure is at the second end of the fiber optic main cable. The splice closure includes a housing coupled to the second end of the fiber optic main cable and a splice control member in the housing. The housing may be a flexible closure. The plurality of splices on the second end of the fiber optic main cable may be positioned on the splice control member. One or more bend radius control member may be on the splice control member and the spliced optical fibers on the splice control member may extend around at least one bend radius control member. The housing may be sealed to the fiber optic main cable. Splice closures may be provided around respective ones of the openings in the fiber optic main cable. The splice closures may be configured to receive drop cables extending from either longitudinal end of the splice closures. The optical fibers extending in the outer optical fiber tube may be bend insensitive optical fibers and the drop cable and at least one of the additional drop cables may extend from different longitudinal ends of the splice closure.

In further embodiments, the fiber optic main cable further includes a strength member within the outer cable sheath. The splice control member is a splice tray that is mechanically coupled to at least one of the outer cable sheath of the fiber optic main cable, the optical fiber tubes or the strength member and movable relative to the fiber optic main cable about at least one axis to allow wrapping of the fiber optic main cable with the splice tray and flexible closure attached thereto around a cable spool. A bend radius control member may be on the splice tray and the spliced second section of the cut optical fiber and the optical fiber in the inner optical fiber tube extend around the bend radius control member. A heat shrink member may couple the flexible housing to the outer cable sheath of the fiber optic main cable.

In yet other embodiments, method of factory terminating an optical fiber cable is provided. The optical fiber cable has a longitudinal central axis and an outer cable sheath, an outer optical fiber tube located within the fiber optic main cable proximate the outer cable sheath and including a plurality of optical fibers extending therein and an inner optical fiber tube located within the fiber optic main cable closer to the longitudinal central axis of the fiber optic main cable than the outer optical fiber tube and including a plurality of optical fibers extending therein. The method includes determining a number of longitudinally offset predetermined termination points to be provided on the optical fiber cable, wherein the number is greater than one. The outer cable sheath is removed from a section of the optical fiber cable corresponding to a first of the termination points to expose a portion of the outer optical fiber tube of the optical fiber cable. A length of the exposed outer optical fiber tube is removed to expose the plurality of optical fibers in the outer optical fiber tube. An exposed one of the plurality of optical fibers is cut. A first section of the cut optical fiber extends from the cut towards a first longitudinal end of the optical fiber cable and a second section of the cut optical fiber extends from the cut to a second end of the optical fiber cable that is longitudinally displaced from the first end. The second section of the cut optical fiber is spliced to one of the plurality of optical fibers in the inner optical fiber tube at the second end of the optical fiber cable.

In further embodiments, the method further includes splicing the first section of the cut optical fiber to an optical fiber of a first drop cable to provide a first splice. The outer cable sheath is removed from a section of the optical fiber cable corresponding to a second of the termination points to expose a portion of the outer optical fiber tube of the optical fiber cable. The second of the termination points is between the first of the termination points and the second end of the optical fiber cable. A length of the exposed outer optical fiber tube is removed to expose the second section of the cut optical fiber in the outer optical fiber tube. The second section of the cut optical fiber is cut and an end of the cut second section of the cut optical fiber that is spliced to the one of the plurality of optical fibers in the inner optical fiber tube is spliced to an optical fiber of a second drop cable to provide a second splice.

In other embodiments, the method includes sliding a number of tubular outer protective housings onto the optical fiber cable. The number of tubular outer protective housings is at least equal to the number of termination points. One of the tubular outer protective housings is slid over each of the sections of the optical fiber cable having the outer cable sheath removed. The outer protective housings are secured to the optical fiber cable to provide an environmental closure around the sections of the optical fiber cable having the outer cable sheath removed with the optical fiber cable extending from respective longitudinally displaced ends of the outer protective housings and the first and second drop cables extending from at least one of the ends of respective ones of the outer protective housings. The optical fibers in the outer optical fiber tube may be bend insensitive optical fibers and securing the outer protective housings may include securing a respective one of the outer protective housings to the optical fiber cable with the first and second drop cables extending from opposite ends of the respective one of the outer protective housings.

### BRIEF DESCRIPTION OF THE DRAWINGS

FIG. 1 is a perspective view illustrating an end of an optical fiber cable to be preterminated according to some embodiments of the present invention;

FIG. 2 is a cross-sectional view of the optical fiber cable of FIG. 1;

FIG. 3 is a perspective view of a splice point according to some embodiments of the present invention on the optical fiber cable of FIG. 1;

FIG. 4 is a perspective view of the splice point of FIG. 3 with a drop cable spliced to an optical fiber of the optical fiber cable according to some embodiments of the present invention;

FIG. 5 is a perspective view of the splice point of FIG. 4 with a cover applied according to some embodiments of the present invention;

FIGS. 6 and 7 are schematic illustrations of installation of the optical fiber cable of FIGS. 1 to 5 in the field according to some embodiments of the present invention.

FIG. 8 is a schematic illustration of the optical fiber cable of FIGS. 1 to 5 showing the mapping of fibers according to some embodiments of the present invention;

FIG. 9A is an exploded perspective view of an end splice for the optical fiber cable of FIGS. 1 to 5 according to some embodiments of the present invention;

FIG. 9B is a perspective view of the end splice of FIG. 9A;

FIG. 10 is a flowchart illustrating operations for terminating an optical fiber according to some embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be described herein, some embodiments of the present invention provide methods and systems for factory splicing a fiber distribution cable to drop tethers to construct an assembly that can then be carried to the field for deployment. Such embodiments may reduce or even minimize field splicing and closure construction. Existing methods for splicing drop tethers in a factory environment generally are directed to ribbon fibers or low count buffer tube cables. Embodiments described herein may be used with large count buffer tube cables. In particular, some embodiments may be used with such cables that are constructed with multiple layers of buffer tubes by facilitating entering the underlying tubes to access the fibers contain therein, while also maintaining cable integrity, which is difficult and often not possible using current methods for factory pretermination.

In some embodiments described herein, these problems may be addressed by back feeding the inner tube fibers to the outer fibers that would normally be cut dead in the field when they are terminated to a tether/drop. Such an approach may further be combined with a splice point closure system that utilizes bend insensitive fiber to facilitate having drops that exit both ends (relative to the longitudinal axis of the cable) of the closure regardless of the direction the originating fiber enters the closure. As such, an issue that has limited or prevented high count buffer tube cables from being used in this factory terminated construction may be addressed.

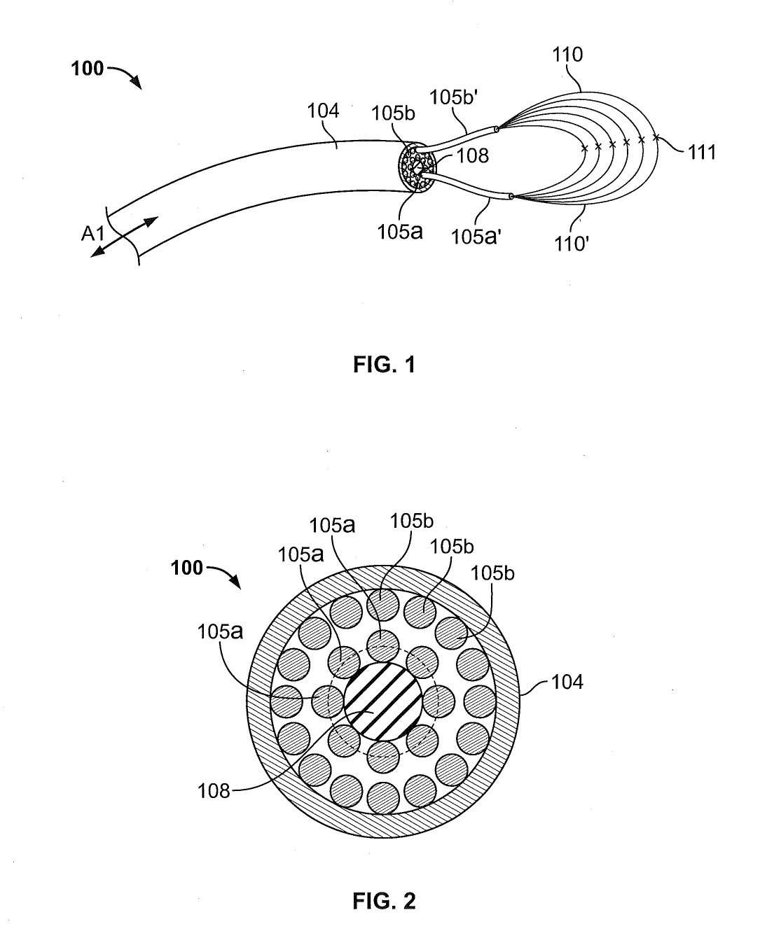

Embodiments of the present invention will now be further described with reference to FIGS. 1-9B. A large count buffer tube optical fiber cable 100 is shown in FIGS. 1 and 2. The optical fiber cable 100 may be supplied wound around and extending from a spool. Embodiments of the present invention may provide factory preterminated optical fiber cables that may be used, for example, in a factory installed termination system (FITS) and/or Verizon advanced termination system (VATS). As will be described herein, some embodiments may provide improved access to fibers in the optical fiber cable 100, particularly for inner optical fibers positioned closer to the central longitudinal axis of the optical fiber cable 100.

As shown in FIGS. 1 and 2, the optical fiber cable 100 includes a plurality of optical fibers 110, 110′, which may be ribbon cables, extending within respective ones of a plurality of buffer tubes 105a, 105b, which longitudinally extend along a neutral (relative to bending) or central longitudinal axis Al of the cable 100. Also shown in the cable 100 is a central strength member 108 that extends along the central axis Al of the cable 100. More particularly, the buffer tubes 105a, 105b include inner buffer tubes 105a, positioned around the central strength member 108, and outer buffer tubes 105b, positioned around the inner buffer tubes 105a. The outer buffer tubes 105b are surrounded by a protective outer cable jacket (sheath) 104. It will be understood that additional features may be present in the cable 100, such as additional protective layers, grounding, shielding or the like. In addition, there may be multiple inner buffer tube layers although only a single inner and outer layer are shown in the Figures.

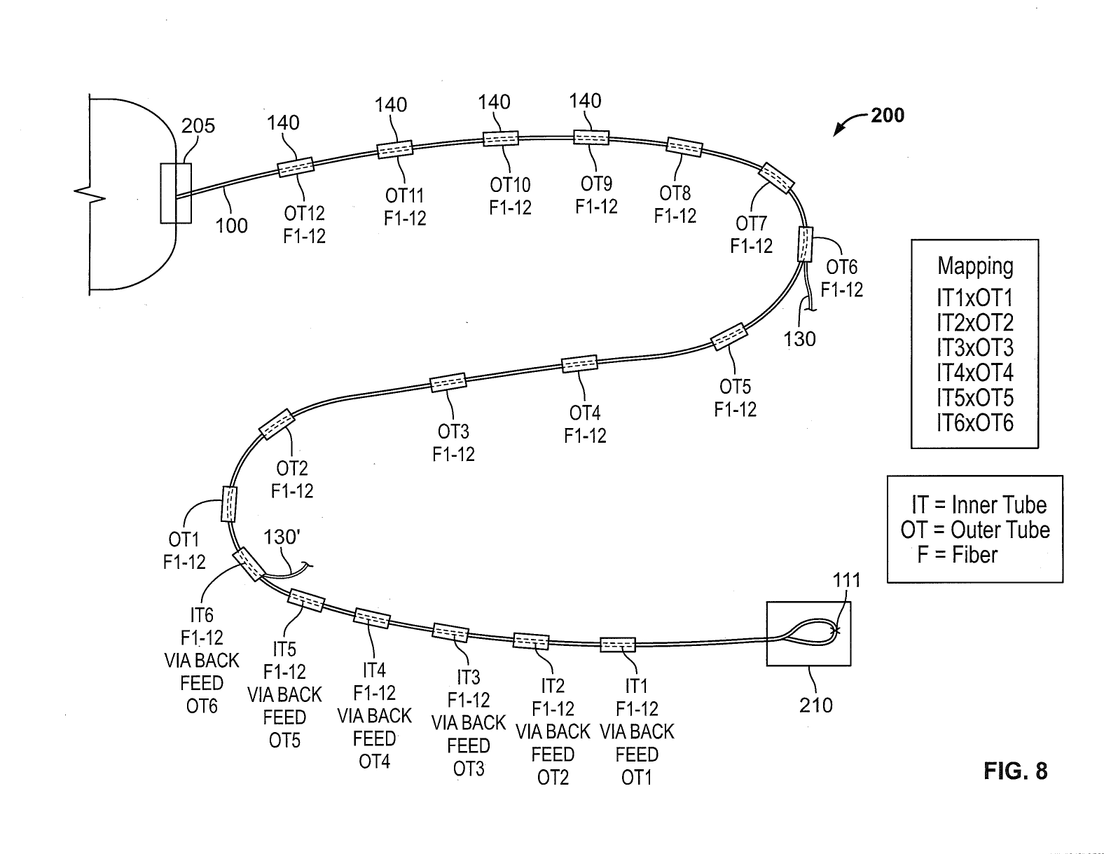

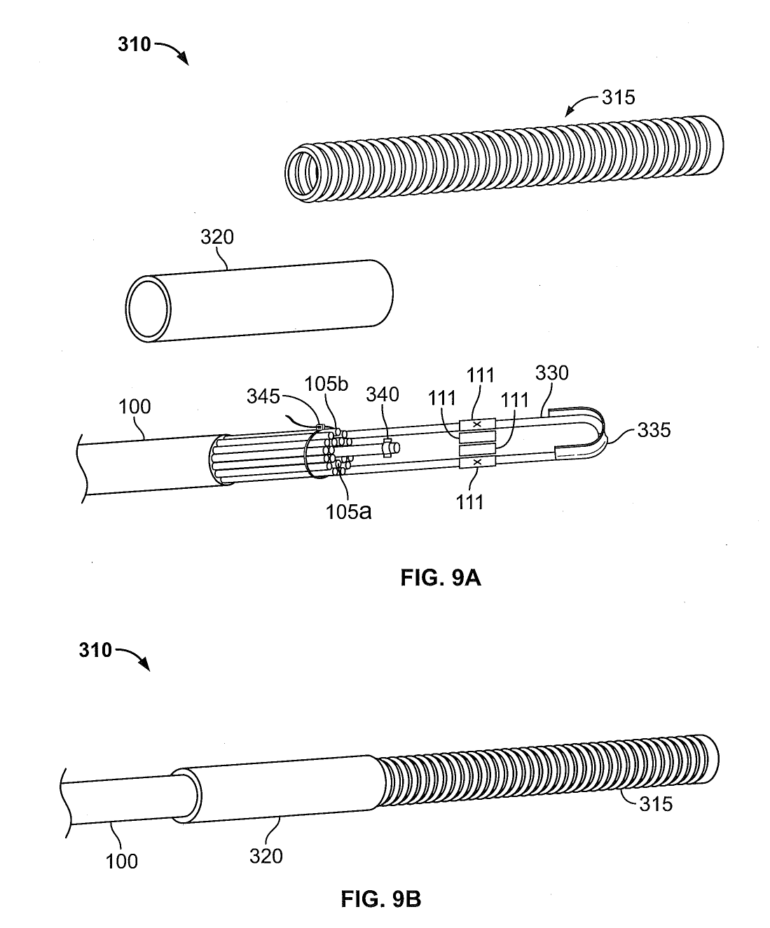

The portion of the cable 100 shown to the right in FIG. 1 corresponds to a first end of the cable, wherein the cable has a second end at the opposite longitudinal end of the cable 100. For purposes of discussion herein the end shown on the right in FIG. 1 will be referred to as the downstream end and the opposite longitudinal end will be referred to as the upstream end of the cable 100. Also shown in FIG. 1 at the downstream end of the cable 100 is a plurality of fibers 110 from one of the outer optical fiber tubes 105b′ that are spliced to corresponding ones of a plurality of fibers 110′ from one of the inner optical fiber tubes 105a′. These downstream end splices 111 will be further described with reference to FIGS. 8 and 9A.

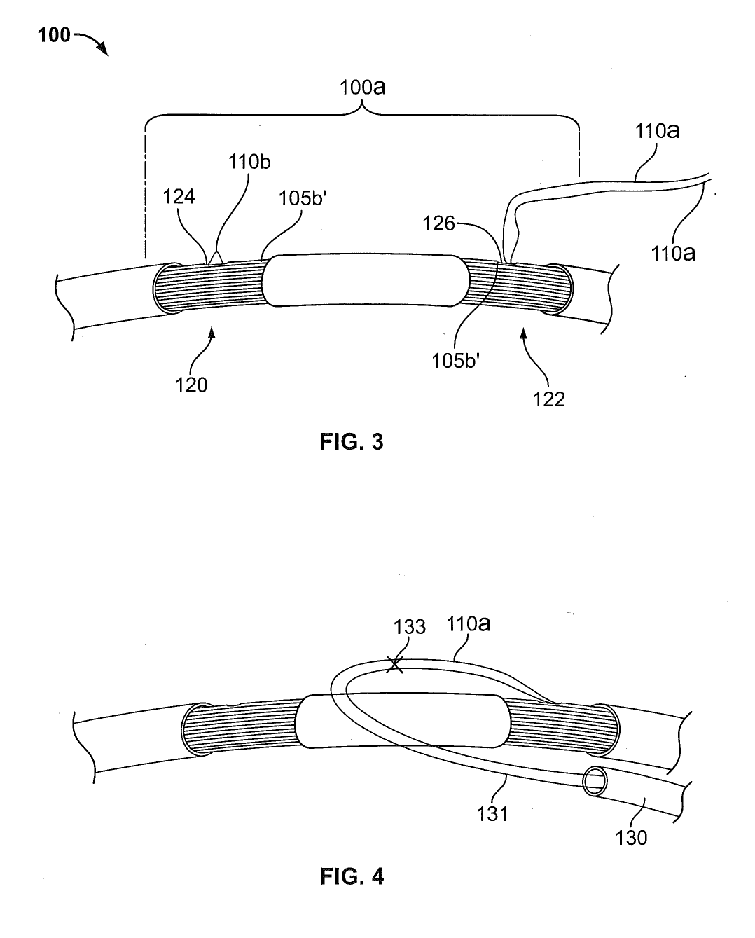

The portion of the cable 100 shown in FIGS. 3-5 corresponds to a termination point (splice location) 100a, where a splice may be made to form a factory preterminated fiber optic cable system where the cable 100 will be the fiber optic main cable having drop cables 130 spliced thereto at a plurality of longitudinally displaced termination points (splice locations) selected to be positioned at corresponding locations during installation in the field, such as in a neighborhood or the like. For the illustrated splice location seen in FIGS. 3 and 4, two openings 120, 122 are formed in the outer cable sheath 104 at longitudinally displaced ends of the splice location 100a. A tube opening 124, 126 is cut into a selected one of the outer optical fiber tubes 105b′ at each opening 120, 122 to expose the optical fibers 110 therein.

In the illustrated embodiments, the optical fibers 110 are accessed through the tube opening 124 and one or more of the optical fibers 110 are cut. The cut one or more optical fibers 110 are pulled through the tube opening 126 at the other opening 122 in the optical fiber main cable 100. It will be understood that, in other embodiments, only a single opening is provided in the outer cable sheath 104 at each splice location 100a, although a greater length of slack for subsequent splicing of the cut fiber(s) may be provided while not overly affecting the cable 100 otherwise using the approach illustrated in FIG. 3 After the above described cutting of a fiber(s), the cut one or more optical fibers will include a first section 110a that extends from the cut at opening 120 towards a first longitudinal end (upstream) of the fiber optic main cable 100 and a second section 110b that extends from the splice location 100a to a second end (downstream) of the fiber optic main cable 100 that is longitudinally displaced from the first end.

It will be understood that the upstream end is to the right as seen in FIGS. 3 and 4. However, in some of the discussion below, these figures will also be referenced in connection with operations related to splicing at a splice location 100a where the downstream end will be to the right as seen in FIGS. 3 and 4. In such cases, the only reference in the figures that does not apply is that both the referenced sections 110a, 110b will, instead, correspond to different portions of the second section 110b.

As seen in FIG. 4, a drop cable(s) 130 having an optical fiber(s) 131 therein is spliced to a corresponding one of the cut fiber section 110a, 110b. As shown in FIG. 4, the optical fiber 131 of the drop cable 130 is coupled to the first section 110a of the cut optical fiber 110. As such, the drop cable 130 is coupled to the upstream (e.g., central office coupled) end of the fiber optic main cable 100 using the fiber 110 in the outer optical fiber tube 105b′.

At a second, downstream, splice location 100a, the second section 110b of the cut optical fiber 110 is accessed and cut substantially as described above. A second drop cable 130 (130′ in FIG. 8) having an optical fiber(s) 131 therein is spliced to the cut second section 110b at the second splice location 100a. More particularly, the second drop cable 130′ is spliced to the portion of the cut second section 110b extending in the downstream direction to couple the fiber 131 of the second drop cable 130′ to an optical fiber in one of the inner optical fiber tubes 105a′. As such, a drop cable 130′ is coupled to the upstream (e.g., central office coupled) end of the fiber optic main cable 100 using the section 110b of the cut optical fiber 110 in the outer optical fiber tube 105b′ and the corresponding fiber 110′ in the inner optical fiber tube 105a′ as will now be further described.

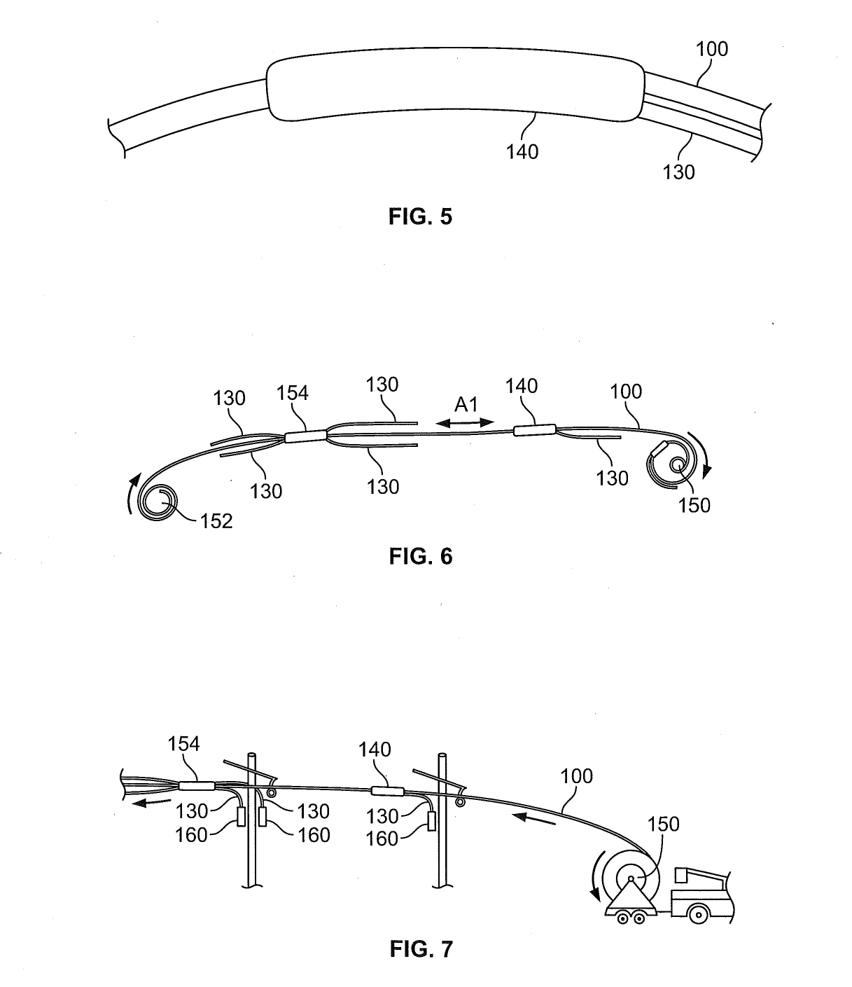

As seen in FIG. 5, in either case, the splice location 100a may then be covered by an outer protective housing 140. For example, the housing 140 may be heat shrink tubing that is positioned over the splice location 100a and coupled thereto by the application of heat. The housing 140, in some embodiments, may be a cast or conventional molded or conventional wrap around heat shrink housing.

Embodiments of the present invention will now be further described with reference to FIG. 8. As seen in the embodiments of FIG. 8, the fiber optic main cable 100 extends from a junction 205, such as a central office or cable junction point, at first (upstream) end thereof to a splice closure 210 at an opposite second (downstream) end thereof For example, the cable may be a high fiber count cable having twelve outer optical fiber tubes (OT) and six inner optical fiber tubes (IT), each tube including a plurality of optical fibers (F1-Fn) therein. The junction splice closure 210 may include a plurality of splices 111 therein that couple second ends 110b of cut fibers in outer optical fiber tubes as discussed above to corresponding fibers of the inner optical fiber tubes. As particularly shown in the illustrated embodiments of FIG. 8, a total of 18 splice locations OT12, OT11, OT10, OT9, OT8, OT7, OT6, OT5, OT4, OT3, OT2, OT1, IT6, ITS, IT4, IT3, IT2, IT1 are provided on the factory preterminated cable 100. The notation used for the splice locations in FIG. 8 corresponds to the tube whose fibers are accessed for service at those locations (from the perspective of the junction 205). The illustrated embodiments further indicate that twelve fibers (F1-F12) are accessed at each location.

FIG. 8 also schematically illustrates the mapping of second sections 110b of respective ones of the fibers in the outer optical fiber tubes to corresponding ones of the fibers in the inner optical fiber tubes for which these second sections 110b provide backfeed providing access to the fibers of the inner tubes through the outer tubes at the locations IT6, ITS, IT4, IT3, IT2, IT1. In other words, this mapping defines the splices 111 that are formed in the splice closure 210 to provide the indicated mapping.

FIG. 8 also illustrates that an outer protective housing 140 may be provided at each location. To simplify illustration, only two drop cables 130, 130′ are shown in FIG. 8. The fibers in the first drop cable 130 may be coupled to the first section of the cut optical fibers from the sixth outer optical fiber tube OT6 to be coupled to the junction 205. The fibers in the second drop cable 130′ may be coupled to the second section of the cut optical fibers from the sixth outer optical fiber tube OT6 that extend to the splice closure 210. At the splice closure, these fibers are spliced 111 to corresponding ones of the fibers from the sixth inner optical fiber tube IT6. As such, the fibers in the drop cable 130′ may be coupled to the fibers from the sixth inner optical fiber tube IT6 at the junction 205 via feedback through the splice closure 210. It will be understood ,however, that one or more drop cables may be provided at each location.

Thus, while generally described with reference to a particular location and single fiber with reference to FIGS. 3-4, embodiments of the present invention include additional optical fibers extending in the inner optical fiber tube 105a′ and the cut optical fiber tube is a plurality of cut optical fibers in the outer optical fiber tube 105b′. Similarly, the splice 111 at the second end of the fiber optic main cable 100 comprises a plurality of splices 11 that couple ones of the additional optical fibers in the inner optical fiber tube 105a′ to respective ones of the cut optical fibers in the outer optical fiber tube 105b′. Furthermore, in addition to the first and second drop cables discussed above, additional drop cables having optical fibers therein may be spliced to respective ones of the cut optical fibers 110 in the outer optical fiber tube 105b′ to couple the additional drop cable optical fibers to the additional optical fibers in the inner optical fiber tube 105a′. As also described with reference to FIG. 8, the outer optical fiber tube 105b′ may be a plurality of outer optical fiber tubes 105b and the inner optical fiber tube 105a′ may be a plurality of inner optical fiber tubes 105a. As such, a plurality of additional openings 122, 124 may be provided in the fiber optic main cable 100 and the additional drop cable optical fibers may be spliced to respective ones of the cut optical fibers 110b in the outer optical fiber tube(s) 105b at respective ones of the additional openings 122, 124 to provide a factory preterminated optical fiber cable having a plurality of drop cables 130, 130′ spliced to the fiber optic main cable 100 at preselected longitudinal locations on the cable 100.

As seen in FIG. 6, the preterminated cable of FIG. 8 may be provided as a spooled cable for field installation. More particularly, the cable 100 may be received on a first spool 152 and transferred to a second spool 150, with closures 140, 154 installed at selected longitudinal locations before winding on the second spool. Note that, as discussed above, the closure 154 covers a splice location 100a where four drop cables 130 are coupled, two each extending from respective longitudinal ends of the closure 154. In some embodiments, bend insensitive optical fibers 110 may be used to facilitate routing of spliced fibers out of the closure in both longitudinal directions (i.e., to ease the ability to rotate a fiber 180° within a low profile closure without unduly reducing optical performance of the fiber (i.e., one that may be spooled on the spool 150 with the closure attached).

As seen in the embodiments of FIG. 7, the spool 150 may then be taken into the field for installation, for example, for aerial installation as seen in FIG. 7. As shown in FIG. 7, the respective locations of the closures 140, 154 may be selected to correspond to telephone pole locations to facilitate coupling of the respective drop cables 130 to corresponding local juncture housings 160.

Referring now to FIGS. 9A and 9B, a splice closure 310 according to some embodiments of the present invention will now be further described. As seen in the embodiments of FIGS. 9A and 9B, the splice closure 310 includes a housing 315 coupled to the second (downstream) end of the fiber optic main cable 100 and a splice control member, shown as a flexible splice tray 330, in the housing 315. The splice tray 330 may be a plastic molded splice tray. The plurality of splices 111 on the second end of the fiber optic main cable 100 are positioned on the splice tray 330. One or more bend radius control members 335 may be provided on the splice tray 330. The spliced optical fibers 110 on the splice tray extend around one or more of the bend radius control members 335. The spliced optical fibers 110 may be spliced by a mass fusion splice 111, which splice 111 may be placed before or after the fibers 110 pass around the bend radius control member(s).

In addition, the housing 315 in the illustrated embodiments is a flexible closure that is sealed to the fiber optic main cable by a heat shrink member 320 that couples the flexible housing 315 to the outer cable sheath 104 of the fiber optic main cable 100. The use of a flexible tray 330 and housing 315 may facilitate wrapping of the preterminated cable 100 around the spool 1150.

As also shown in the embodiments of FIGS. 9A and 9B, the splice tray 330 is mechanically coupled to one or more components of the cable 100. As seen in FIG. 9A, the splice tray is coupled to the bundle of all the optical fiber tubes 105a, 105b by a twist tie 345. In addition, the tray 330 is shown as being coupled to the strength member 108 by a clamp 340. Such an arrangement may facilitate wrapping of the cable 100 on the spool 150 by providing a splice tray 330 that is movable relative to the fiber optic main cable 100 about at least one axis r to allow wrapping of the fiber optic main cable 100 with the splice tray 330 and flexible closure 315 attached thereto around the cable spool 150.

Thus, as described above, a factory preterminated optical fiber cable having a plurality of drop cables spliced to the main cable in housings positioned at a plurality of predetermined longitudinal positions on the cable may be provided in some embodiments of the present invention.

It will further be understood that other embodiments of the present invention provide splice closures for use in such factory preterminating.

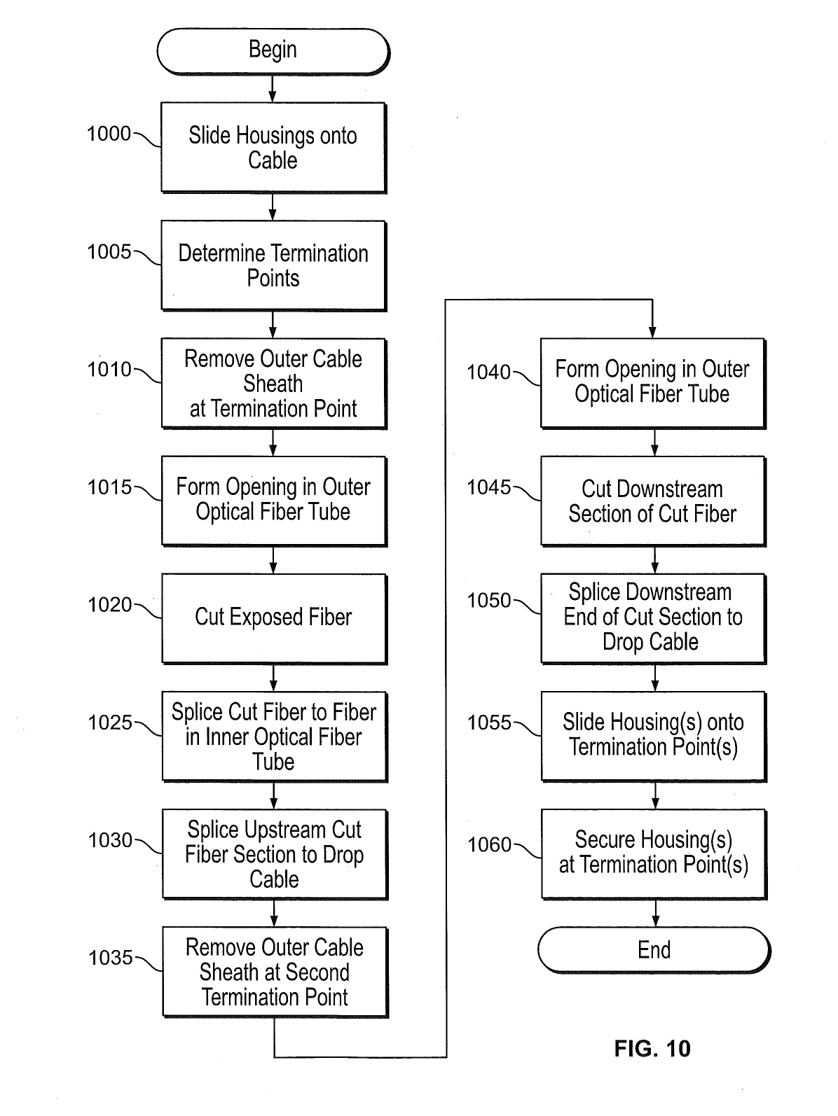

Methods of factory terminating an optical fiber cable according to some embodiments of the present invention will now be described with reference to the flowchart illustration of FIG. 10. The optical fiber cable has a strength member within an outer cable sheath, an outer optical fiber tube located within the fiber optic main cable proximate the outer cable sheath and including a plurality of optical fibers extending therein and an inner optical fiber tube located within the fiber optic main cable closer to a longitudinal central axis of the fiber optic main cable than the outer optical fiber tube and including a plurality of optical fibers extending therein As seen in FIG. 10, for some embodiments, operations begin at Block 1000 by sliding a number of tubular outer protective housings onto the optical fiber cable, wherein the number of tubular outer protective housings is at least equal to the number of termination points.

A number of longitudinally offset predetermined termination (splice) points to be provided on the optical fiber cable is determined (Block 1005). The outer cable sheath is removed from a section of the optical fiber cable corresponding to a first of the termination points to expose a portion of the outer optical fiber tube of the optical fiber cable (Block 1010). A length of the exposed outer optical fiber tube is removed, for example, by cutting an opening in the tube, to expose the plurality of optical fibers in the outer optical fiber tube (Block 1015). It will be understood that the operations at Blocks 1010 and 1015 may leave a remaining portion of the outer cable sheath or tube to provide, for example, a scalloped opening for fiber access rather than removing an entire section as seen for access through the outer cable sheath in FIGS. 3 and 4.

An exposed one of the plurality of optical fibers is cut (Block 1020). After the cut, a first section of the cut optical fiber extends from the cut towards a first longitudinal end of the optical fiber cable and a second section of the cut optical fiber extends from the cut to a second end of the optical fiber cable that is longitudinally displaced from the first end. the second section of the cut optical fiber is spliced to one of the plurality of optical fibers in the inner optical fiber tube at the second end of the optical fiber cable (Block 1025).

In some embodiments, the first section of the cut optical fiber is spliced to an optical fiber of a first drop cable to provide a first splice (Block 1030). The outer cable sheath is removed from a section of the optical fiber cable corresponding to a second of the termination points to expose a portion of the outer optical fiber tube of the optical fiber cable (Block 1035). The second of the termination points is between the first of the termination points and the second end of the optical fiber cable. A length of the exposed outer optical fiber tube is removed to expose the second section of the cut optical fiber in the outer optical fiber tube (Block 1040). The second section of the cut optical fiber is cut (Block 1045). An end of the cut second section of the cut optical fiber that is spliced to the one of the plurality of optical fibers in the inner optical fiber tube is spliced to an optical fiber of a second drop cable to provide a second splice (Block 1050).

In further embodiments where the operations at Block 1000 have been carried out, operations further include sliding one of the tubular outer protective housings over each of the sections of the optical fiber cable having the outer cable sheath removed (Block 1055). The outer protective housings are secured to the optical fiber cable to provide an environmental closure around the sections of the optical fiber cable having the outer cable sheath removed with the optical fiber cable extending from respective longitudinally displaced ends of the outer protective housings and the first and second drop cables extending from at least one of the longitudinally displaced ends of respective ones of the outer protective housings (Block 1060).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A fiber optic cable system comprising:
a fiber optic main cable having a longitudinal central axis and an outer cable sheath;
an outer optical fiber tube located within the fiber optic main cable proximate the outer cable sheath and including a plurality of optical fibers extending therein;
an inner optical fiber tube located within the fiber optic main cable closer to the longitudinal central axis of the fiber optic main cable than the outer optical fiber tube and including an optical fiber extending therein;
a first splice location in the fiber optic main cable at a first longitudinal position along the fiber optic main cable, wherein one of the plurality of optical fibers in the outer optical fiber tube is cut at the first splice location and wherein a first section of the cut optical fiber extends from the cut towards a first longitudinal end of the fiber optic main cable and a second section of the cut optical fiber extends from the cut to a second end of the fiber optic main cable that is longitudinally displaced from the first end; and
a splice at the second end of the fiber optic main cable that couples the second section of the cut optical fiber to the optical fiber in the inner optical fiber tube.

2. The fiber optic cable system of claim 1, further comprising a second splice location in the fiber optic main cable at a second longitudinal position along the fiber optic main cable between the first longitudinal position and the second end of the fiber optic main cable, wherein the second section of the cut optical fiber is cut at the second splice location.

3. The fiber optic cable system of claim 2, wherein the first splice location comprises a first opening in the fiber optic main cable, wherein the cut optical fiber is exposed by the first opening and wherein the second splice location comprises a second opening in the fiber optic main cable, wherein the cut second section of the cut optical fiber is exposed by the second opening.

4. The fiber optic cable system of claim 3, further comprising:
a first drop cable having an optical fiber therein, wherein the first drop cable optical fiber is spliced to the first section of the cut optical fiber at the first opening; and
a second drop cable having an optical fiber therein, wherein the second drop cable optical fiber is spliced to the cut second section of the cut optical fiber at the second opening to couple the second drop cable optical fiber to the optical fiber in the inner optical fiber tube.

5. The fiber optic cable system of claim 4, further comprising additional optical fibers extending in the inner optical fiber tube and wherein the cut optical fiber comprises a plurality of cut optical fibers in the outer optical fiber tube and wherein the splice at the second end of the fiber optic main cable comprises a plurality of splices that couple ones of the additional optical fibers in the inner optical fiber tube to respective ones of the cut optical fibers in the outer optical fiber tube.

6. The fiber optic cable system of claim 5, further comprising additional drop cables having optical fibers therein, wherein the additional drop cable optical fibers are spliced to respective ones of the cut optical fibers in the outer optical fiber tube to couple the additional drop cable optical fibers to the additional optical fibers in the inner optical fiber tube.

7. The fiber optic cable system of claim 6, wherein the outer optical fiber tube comprises a plurality of outer optical fiber tubes and wherein the inner optical fiber tube comprises a plurality of inner optical fiber tubes.

8. The fiber optic cable system of claim 7, further comprising a plurality of additional openings in the fiber optic main cable and wherein the additional drop cable optical fibers are spliced to respective ones of the cut optical fibers in the outer optical fiber tube at respective ones of the additional openings to provide a factory preterminated optical fiber cable having a plurality of drop cables spliced to the fiber optic main cable.

9. The fiber optic cable system of claim 8, further comprising a splice closure at the second end of the fiber optic main cable, wherein the splice closure comprises:
a housing coupled to the second end of the fiber optic main cable; and
a splice control member in the housing, wherein the plurality of splices on the second end of the fiber optic main cable are positioned on the splice control member.

10. The fiber optic cable system of claim 9, further comprising at least one bend radius control member on the splice control member, wherein the spliced optical fibers on the splice control member extend around the at least one bend radius control member.

11. The fiber optic cable system of claim 9, wherein the housing is sealed to the fiber optic main cable.

12. The fiber optic cable system of claim 9, further comprising splice closures around respective ones of the openings in the fiber optic main cable, wherein the splice closures are configured to receive drop cables extending from either longitudinal end of the splice closures.

13. The fiber optic cable system of claim 12, wherein the optical fibers extending in the outer optical fiber tube comprise bend insensitive optical fibers and wherein the drop cable and at least one of the additional drop cables extend from different longitudinal ends of the splice closure.

14. The fiber optic cable system of claim 1, further comprising a splice closure at the second end of the fiber optic main cable, wherein the splice closure comprises:
a housing coupled to the second end of the fiber optic main cable; and
a splice control member in the housing, wherein the splice at the second end of the fiber optic main cable is positioned on the splice control member.

15. The fiber optic cable system of claim 14, wherein the housing comprises a flexible closure.

16. The fiber optic cable system of claim 15, wherein the fiber optic main cable further includes a strength member within the outer cable sheath and wherein the splice control member comprises a splice tray that is mechanically coupled to at least one of the outer cable sheath of the fiber optic main cable, the optical fiber tubes or the strength member and movable relative to the fiber optic main cable about at least one axis to allow wrapping of the fiber optic main cable with the splice tray and flexible closure attached thereto around a cable spool.

17. The fiber optic cable system of claim 16, further comprising a bend radius control member on the splice tray and wherein the spliced second section of the cut optical fiber and the optical fiber in the inner optical fiber tube extend around the bend radius control member.

18. The fiber optic cable system of claim 15, further comprising a heat shrink member that couples the flexible housing to the outer cable sheath of the fiber optic main cable.

19. A method of factory terminating an optical fiber cable having a longitudinal central axis and an outer cable sheath, an outer optical fiber tube located within the fiber optic main cable proximate the outer cable sheath and including a plurality of optical fibers extending therein and an inner optical fiber tube located within the fiber optic main cable closer to the longitudinal central axis of the fiber optic main cable than the outer optical fiber tube and including a plurality of optical fibers extending therein, the method comprising:
determining a number of longitudinally offset predetermined termination points to be provided on the optical fiber cable, wherein the number is greater than one;
removing the outer cable sheath from a section of the optical fiber cable corresponding to a first of the termination points to expose a portion of the outer optical fiber tube of the optical fiber cable;
removing a length of the exposed outer optical fiber tube to expose the plurality of optical fibers in the outer optical fiber tube;
cutting an exposed one of the plurality of optical fibers, wherein a first section of the cut optical fiber extends from the cut towards a first longitudinal end of the optical fiber cable and a second section of the cut optical fiber extends from the cut to a second end of the optical fiber cable that is longitudinally displaced from the first end; and
splicing the second section of the cut optical fiber to one of the plurality of optical fibers in the inner optical fiber tube at the second end of the optical fiber cable.

20. The method of claim 19, further comprising:
splicing the first section of the cut optical fiber to an optical fiber of a first drop cable to provide a first splice;
removing the outer cable sheath from a section of the optical fiber cable corresponding to a second of the termination points to expose a portion of the outer optical fiber tube of the optical fiber cable, wherein the second of the termination points is between the first of the termination points and the second end of the optical fiber cable;
removing a length of the exposed outer optical fiber tube to expose the second section of the cut optical fiber in the outer optical fiber tube;
cutting the second section of the cut optical fiber; and
splicing an end of the cut second section of the cut optical fiber that is spliced to the one of the plurality of optical fibers in the inner optical fiber tube to an optical fiber of a second drop cable to provide a second splice.

21. The method of claim 20, further comprising sliding a number of tubular outer protective housings onto the optical fiber cable, wherein the number of tubular outer protective housings is at least equal to the number of termination points;
sliding one of the tubular outer protective housings over each of the sections of the optical fiber cable having the outer cable sheath removed; and
securing the outer protective housings to the optical fiber cable to provide an environmental closure around the sections of the optical fiber cable having the outer cable sheath removed with the optical fiber cable extending from respective longitudinally displaced ends of the outer protective housings and the first and second drop cables extending from at least one of the ends of respective ones of the outer protective housings.

22. The method of claim 21, wherein the optical fibers in the outer optical fiber tube comprise bend insensitive optical fibers and wherein securing the outer protective housings includes securing a respective one of the outer protective housings to the optical fiber cable with the first and second drop cables extending from opposite ends of the respective one of the outer protective housings.
